(19) United States
(12) Patent Application Publication
(10) Pub. No.: US 2014/0295760 A1
(43) Pub. Date: Oct. 2, 2014

(54) TERMINAL AND METHOD FOR ESTABLISHING A WIRELESS COMMUNICATION CONNECTION

(71) Applicant: Pantech Co., Ltd., Seoul (KR)

(72) Inventors: Mi Ji PARK, Seoul (KR); Ui Jun PARK, Seoul (KR)

(73) Assignee: Pantech Co., Ltd., Seoul (KR)

(21) Appl. No.: 14/190,440

(22) Filed: Feb. 26, 2014

(30) Foreign Application Priority Data
Mar. 29, 2013 (KR) 10-2013-0034317

(51) Int. Cl. H04W 76/02; H04W 4/00; H04W 8/00

(52) U.S. Cl. CPC H04W 76/023; H04W 8/005; H04W 4/008
USPC 455/41.2

(57) ABSTRACT

A method for establishing a local wireless communication connection includes searching, by a first terminal, for a second terminal capable of establishing a local wireless communication connection with the first terminal; obtaining identification information from the second terminal; determining whether the identification information of the second terminal corresponds to information stored in the first terminal; obtaining user identification information corresponding to the second terminal if the identification information of the second terminal corresponds to the information stored in the first terminal; and displaying, on the first terminal, the user identification information of the second terminal for selection.

### CROSS-REFERENCE TO RELATED APPLICATION

This application claims priority from and the benefit under 35 U.S.C. §119(a) of Korean Patent Application No. 10-2013-0034317, filed on Mar. 29, 2013, the entire disclosure of which is incorporated herein by reference for all purposes.

### BACKGROUND

1. Field

The following description relates to a terminal and a method for providing a user interface for establishing a wireless communication connection.

2. Discussion of the Background

Along with development of electronic communication technologies, a wireless communication technique has been broadly used in various industrial fields, including a service field as well as a communication field. Accordingly, various kinds of service, such as voice call, data transmission, Internet or the like are provided based on a wireless network. The wireless communication technologies based on a wireless network include Bluetooth®, Wireless Fidelity (WiFi) or the like.

Among them, the WiFi-Direct technology allows communication among terminals without use of an access point (AP) (e.g., a wireless sharer), which is required by WiFi, and may quickly transmit large amounts of data in a longer distance in comparison to Bluetooth®. Since smart phones are becoming more widely used and the necessity of data exchange with other terminals, such as notebooks, tablet personal computer (PC) or the like is rapidly increasing, the WiFi-Direct technology is receiving more interest.

Hereinafter, a method for connecting terminals according to a general WiFi-Direct technology will be described with reference to FIG. 1 and FIG. 2.

As shown in FIG. 1, the WiFi-Direct communication is performed without an intermediary or supporting connection device (e.g., an access point) among terminals. More specifically, one terminal may establish a wireless connection with another device without relying on an access point. The following description of FIG. 1 will be based on communication between a first terminal 10 and a second terminal 20.

First, when a user of a first terminal 10 performs data transmission with a second terminal 20, a request for establishing a WiFi-Direct communication connection is inputted to the first terminal 10. Accordingly, the first terminal 10 sends a request for establishing a WiFi-Direct communication connection to the second terminal 20 in operation S10.

A user of the second terminal 20 also inputs a request for establishing a communication connection with the first terminal 10. Accordingly, the second terminal 20 sends a request for establishing a WiFi-Direct communication connection to the first terminal 10. In response to bilateral requests, the first terminal 10 and the second terminal 20 are connected to each other using WiFi-Direct in operation S11.

In addition, in order to allow the second terminal 20 to identify the first terminal 10, the first terminal 10 sends its device information to the second terminal 20 in operation S12.

After sending the device information, the first terminal 10 comes to a standby state in operation S14a. In operation S13, the user of the second terminal 20 requests a search for other terminals in order to identify terminals available for establishing WiFi-Direct communication connection.

In operation S14, the second terminal 20 searches for the available terminals. In operation S15, the second terminal 20 informs the user of the available terminals, which may be capable of communicating with the second terminal 20 using WiFi-Direct communication. For s example, if the second terminal 20 is capable of communicating with the first terminal 10 via WiFi-Direct communication, the first terminal 10 will be provided in a search result.

Subsequently, the user makes an input to select one of a plurality of terminals suggested or identified in the search result in operation S16.

In operation S17, the second terminal 20 sends a data transmission connection request to the terminal selected by the user, and the first terminal 10 receives the connection request to complete the communication connection between both terminals using WiFi-Direct.

Further, a user interface for displaying the search result to the second terminal 20 is shown in FIG. 2. Referring to FIG. 2, information related to the second terminal 20 is displayed in “My Device Information”. Further, terminals capable of establishing a WiFi-Direct communication connection with the second terminal 20 are displayed in a list under “Selection of Device to which Image is to be sent.” The information of the first terminal 10 is displayed here.

In detail, the information of the first terminal 10 displayed at the user interface of the second terminal 20 includes a device image MI1, a device name MI2, and a media access control (MAC) address MI3 of the first terminal 10.

However, the device image MI1 may be displayed identically for the same terminal models and may not be as helpful in identifying a particular device when multiple terminals of the same model are displayed in a search result of connectable devices. Further, the device name MI2 is a name made by a manufacturer, which may not be familiar to the user. Also, the MAC address M13 also has a unique device number format, which may not be familiar to the user. Therefore, when a plurality of terminals are provided in a list of connectable terminals, the user may not easily identify or select a desired terminal through the user interface using the provided device information. Since more types of terminals are connectable through WiFi-Direct, the demand for WiFi-Direct communication is increasing. However, the current user interface may not be helpful in easily recognizing a desired terminal for selection by the user, which has been indicated as a problem.

### SUMMARY

Exemplary embodiments of the present invention provide a terminal and a method for providing a user interface for establishing a wireless communication connection.

Additional features of the invention will be set forth in the description which follows, and in part will be apparent from the description, or may be learned by practice of the invention.

Exemplary embodiments of the present invention provide a method for establishing a local wireless communication connection including searching, by a first terminal, for a second terminal capable of establishing a local wireless communication connection with the first terminal; obtaining identification information from the second terminal; determining whether the identification information of the second terminal corresponds to information stored in the first terminal; obtaining user identification information corresponding to the second terminal if the identification information of the second terminal corresponds to the information stored in the first terminal; and displaying, on the first terminal, the user identification information of the second terminal for selection.

Exemplary embodiments of the present invention provide a first terminal to establish a local wireless communication connection including a data transmission unit to search to identify a second terminal capable of establishing a local wireless communication connection with the first terminal, and to obtain identification information from the second terminal; a storage unit to store device identification list and user identification information corresponding to the device identification list; a control unit to determine whether the identification information of the second terminal corresponds to information included in the device identification list; a user identification information providing unit to obtain user identification information corresponding to the second terminal if the identification information of the second terminal corresponds to the information included in the device identification list; and a display unit to display the user identification information of the second terminal for selection.

Exemplary embodiments of the present invention provide a method for establishing a local wireless communication connection including searching, by a first terminal, for a second terminal capable of establishing a local wireless communication connection with the first terminal; determining whether the second terminal is associated with an encoded phone number; obtaining the encoded phone number associated with the second terminal; decoding the encoded phone number; determining whether the decoded phone number corresponds to a phone number stored in the first terminal; determining whether user identification information corresponding to the decoded phone number is stored in the first terminal; and displaying, on the first terminal, the user identification information in association with the second terminal for selection.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the principles of the invention.

FIG. 1 is a flowchart for illustrating a general WiFi-Direct communication connection among terminals according to a related art.

FIG. 2 shows a user interface displayed on a terminal performing a general WiFi-Direct communication connection according to a related art.

FIG. 3 is a diagram illustrating a wireless communication system according to an exemplary embodiment of the present invention.

FIG. 4 is a diagram illustrating a user identification information providing unit according to an exemplary embodiment of the present invention.

FIG. 5 is a flowchart illustrating a WiFi-Direct communication connection among terminals according to an exemplary embodiment of the present invention.

FIG. 6A, FIG. 6B, FIG. 6C, and FIG. 6D illustrate a user interface displayed on a terminal capable of establishing a WiFi-Direct communication connection according to an exemplary embodiment of the present invention.

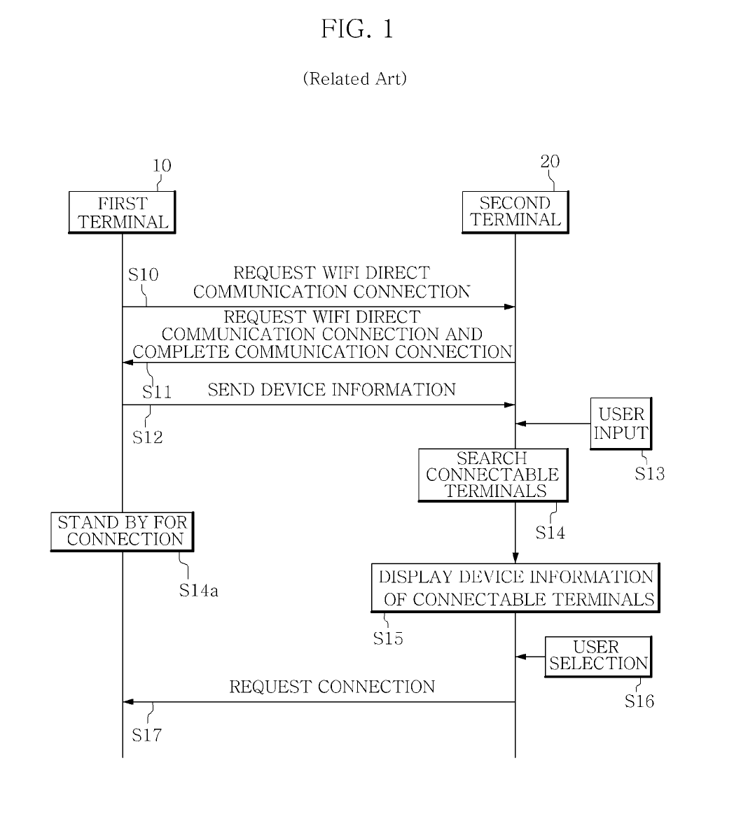

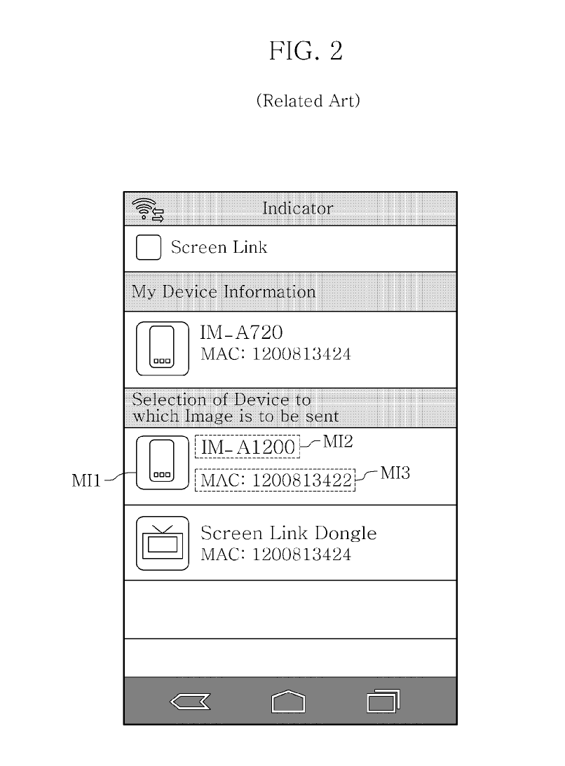

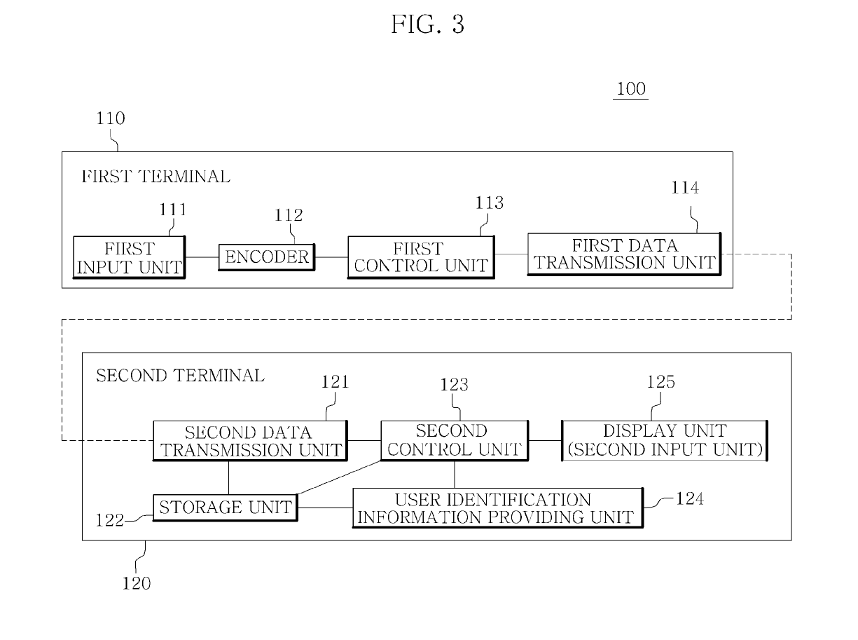

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. It will be understood that for the purposes of this disclosure, “at least one of X, Y, and Z” can be construed as X only, Y only, Z only, or any combination of two or more items X, Y, and Z (e.g., XYZ, XZ, XYY, YZ, ZZ). Throughout the drawings and the detailed description, unless otherwise described, the same drawing reference numerals are understood to refer to the same elements, features, and structures. The relative size and depiction of these elements may be exaggerated for clarity.

The terminology used herein is for the purpose of describing particular exemplary embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. Although some features may be described with respect to individual exemplary embodiments, aspects need not be limited thereto such that features from one or more exemplary embodiments may be combinable with other features from one or more exemplary embodiments.

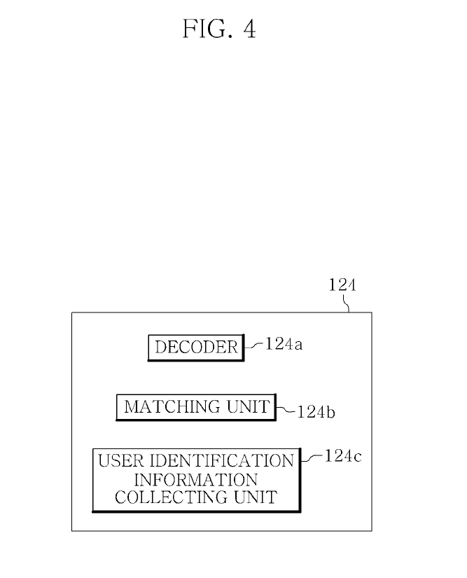

FIG. 3 is a diagram illustrating a wireless communication system according to an exemplary embodiment of the present invention. FIG. 4 is a diagram illustrating a user identification information providing unit according to an exemplary embodiment of the present invention.

Referring to FIG. 3, the wireless communication system includes two terminals. However, aspects of the invention are not limited thereto, such that more than two terminals may be present in the wireless communication system. For example, a wireless communication system may include a plurality of terminals having the same configuration as the first terminal 110 or second terminal 120 that communicate with each other. Although only communication between the first terminal 110 and the second terminal 120 is described below, aspects of the invention may be applied to communication between the first terminal 110 and a plurality of other terminals or between the second terminal 120 and a plurality of other terminals. In addition, although the terminals of FIG. 3 and the user identification information providing unit of FIG. 4 are described with respect to WiFi-Direct, aspects of the invention are not limited thereto, such that other direct communication or local wireless communication technologies, such as near field communication (NFC), Bluetooth®, WiFi Display or the like may be used.

The first terminal 110 may be a terminal for sending information of the terminal to another terminal, namely the second terminal 120. Referring to FIG. 3, the first terminal 110 includes a first input unit 111, an encoder 112, a first control unit 113 and a first data transmission unit 114. Further, although not shown in FIG. 3, a terminal may include hardware components, such as one or more processors, a memory, a touch screen display, a camera, and the like. Also, the units, modules, elements, devices, applications, and components of the apparatuses, systems, and/or terminals herein described, may include hardware and software, may also include firmware, to perform various operations of the terminal including those described herein, may be combined or remain separate, and may be stored in one or more storage devices or computer-readable media. A terminal may be, without limitation, a cellular telephone, a smartphone, a tablet computer, a laptop computer, a desktop computer, and the like.

The first input unit 111 may receive an input of the user. For example, the first input unit 111 may be a touch screen, a keypad or the like. If the first input unit 111 is configured to have a touch screen, the first input unit 111 may also operate as a display unit simultaneously. The user may input a request for connecting to the second terminal 120 via a WiFi-Direct communication by using the first input unit 111.

The encoder 112 may encode specific information of the first terminal 110 through which the second terminal 120 may identify the first terminal 110. More specifically, the encoder 112 may encode device identification information of the first terminal 110. The device identification information may be unique for each terminal and may be inherent information for identifying the first terminal 110. In addition, this encoding process may support easier data transmission since data to be transmitted to the second terminal 120 may be compressed. Further, the encoding process may also be advantageous in terms of security. The device identification information may include, without limitation, a phone number and device information of the respective terminal. The device information may include, without limitation, a device image, a device name, and a unique device number (e.g., a MAC address).

The first control unit 113 may control a first data transmission unit 114, described later, according to the user input to control WiFi-Direct communication connection. Further, the first control unit 113 may also control the transmission of the encoded device identification information of the first terminal 110. When receiving a user input for requesting WiFi-Direct communication connection, the first control unit 113 may operate the first data transmission unit 114 to request WiFi-Direct communication connection to the second terminal 120. In addition, after the WiFi-Direct communication connection request is made to the second terminal 120, the first control unit 113 transmits the encoded device identification information (e.g., the phone number information, the device information, and the like) of first terminal 110. Moreover, when the first terminal 110 and the second terminal 120 are selected by the user, the user may control the first terminal 110 to transmit the data to be executed at the second terminal 120.

The first data transmission unit 114 may send or receive data to/from other terminals, namely, the second terminal 120, according to the control of the first control unit 113. The first data transmission unit 114 may send a message for requesting or establishing a WiFi-Direct communication connection with the second terminal 120. Further, the first data transmission unit 114 may also receive a message for requesting or establishing a WiFi-Direct communication from other terminals. In addition, the first data transmission unit 114 may send device information and/or other information of the first terminal 110. Further, the first data transmission unit 114 may also receive the encoded phone number information and/or other information from other terminals.

The second terminal 120 may be a terminal for receiving information from the first terminal 110. Referring to FIG. 3, the second terminal 120 includes a second data transmission unit 121, a storage unit 122, a second control unit 123, a user identification information providing unit 124, and a display unit 125.

The second data transmission unit 121 may send or receive data with respect to another terminal, such as the first terminal 110. The second data transmission unit 121 may send a message for requesting or establishing a WiFi-Direct communication connection to the first terminal 110. When both the first terminal 110 and the second terminal 120 receives the message for requesting or establishing a WiFi-Direct communication connection, the WiFi-Direct communication connection may be established for transmitting or receiving WiFi-Direct communication. Further, the second data transmission unit 121 may receive device identification information of other terminal (e.g., first terminal 110), which may be transmitted from the other terminal (e.g., first terminal 110). More specifically, the second data transmission unit 121 may receive at least one of device information and encoded phone number information of the other terminal (e.g., first terminal 110).

The storage unit 122 may store and/or retrieve at least one of the data received through or by the second data transmission unit 121, device identification list, and user identification information corresponding to the device identification list. The data received from the second data transmission unit 121 may include device information and/or encoded phone number information of other terminal (e.g., first terminal 110). In addition, the device identification list may refer to a list including device identification information of other terminals except for the second terminal. For example, the device identification list may include a phone number list of other terminals, which may be stored by the second terminal 120. The user identification information may refer to an owner of a terminal corresponding to a phone number stored in the phone number list.

The second control unit 123 may provide the device identification information of the other terminal, which may be received from the second data transmission unit 121. The device identification information of the other terminal may be provided or displayed through the display unit 125 according to the request of the user. The second control unit 123 may receive encoded device identification information (e.g., phone number information and/or device information) from the other terminal, such as the first terminal 110. For example, the second control unit 123 may receive the encoded phone number information from the first terminal 110 having the encoder 112. However, aspects of the invention are not limited thereto, such that the second control unit 123 may be capable of receiving device information from terminals not having the encoder 112. Therefore, when terminals capable of conducting WiFi-Direct communication are searched for at the request of the user, the device identification information (e.g., phone number information and/or device information) received from one or more terminals capable of conducting WiFi Direct communication may be provided as information of available terminals. When the second control unit 123 receives encoded phone number information of a specific terminal through the second data transmission unit 121, the user identification information providing unit 124 may collect identification information of a user of the other terminal corresponding to the encoded phone number information and may provide the identification information to the display unit 125.

The user identification information providing unit 124 may decode the encoded device identification information and provide identification information stored in the second terminal 120, which may correspond to the decoded device identification information. Referring to FIG. 4, the user identification information providing unit 124 includes a decoder 124a, a matching unit 124b, and a user identification information collecting unit 124c.

The decoder 124a may decode the encoded device identification information of the other terminal.

The matching unit 124b may compare the decoded device identification information of the other terminal with the device identification list stored in the storage unit 122 of the second terminal 120 and determine whether matched device identification information is present. For example, if the decoded phone number information of the first terminal 110 is 010-1234-5678, the matching unit 124b determines by comparison whether the phone number list has a phone number identical or corresponding to 010-1234-5678.

When the matched device identification information is present in the device identification list, the user identification information collecting unit 124c may collect, determine, or obtain user identification information corresponding to the matched device identification information from the storage unit 122 and transmit the user identification information to the second control unit 123. For example, the user identification information collecting unit 124c may determine whether user identification information corresponding to 010-1234-5678 is present, and if present, the user identification collecting unit 124c may collect and/or transmit the user identification information to the second control unit 123. According to aspects of the invention, the user identification information may include at least one of an image of the user, a name of the user, or the like.

The display unit 125 may receive a user input and display information corresponding to the user input. For example, the display unit 125 may be configured as a touch screen to receive a user input and/or display information processed by the second terminal 120. Such a display unit may be referred to as a second input unit. More specifically, if the second terminal 120 and the other terminal are connected using a WiFi-Direct communication connection, the user may input a request for searching for communication-available terminals, or terminals capable of conducting a WiFi-Direct communication, to the display unit 125. Further, the display unit 125 may transmit the user input to the second control unit 123 to process device identification information (e.g., device information and/or user identification information) of communication-available terminals for display on the display unit 125

Although the first terminal 110 and the second terminal 120 are illustrated as being composed of different components, aspects of the invention are not limited thereto. More specifically, the first terminal 110 may be configured to receive information from other terminals, and the second terminal 120 may be configured to send information to other terminals. However, the terminals may be configured to perform different or both operations, such that the each terminal may be configured to include the encoder 112, the user identification information collecting unit 124c, or the like.

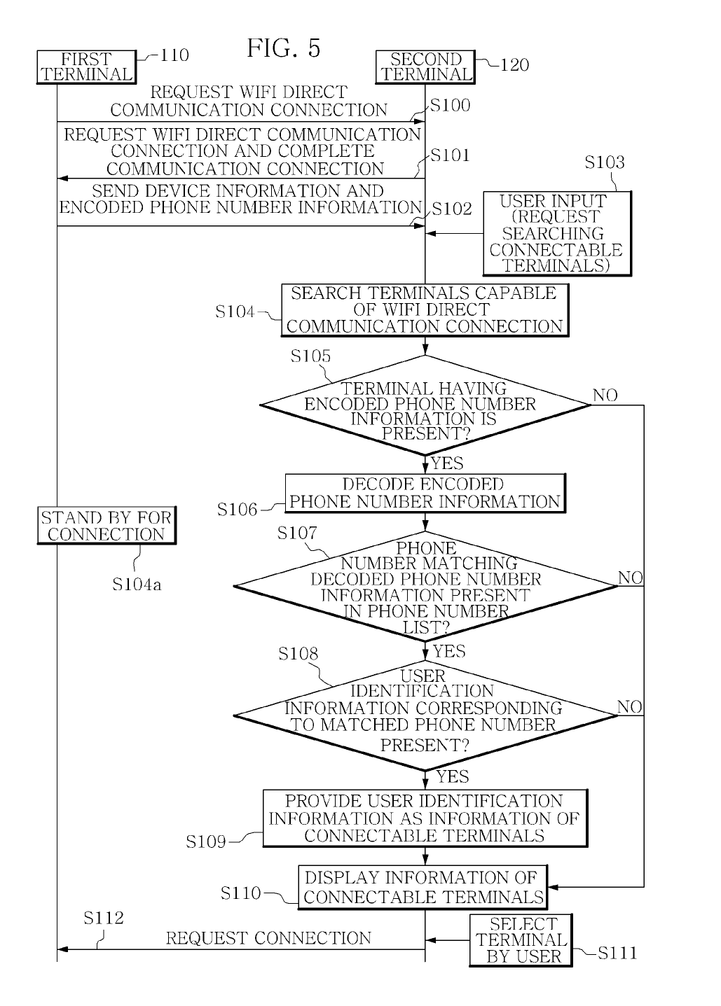

A user interface for performing WiFi-Direct communication connection through the wireless communication system according to an exemplary embodiment of the present invention will be described in more detail with reference to FIG. 5. FIG. 5 is a flowchart illustrating a WiFi-Direct communication connection among terminals according to an exemplary embodiment of the present invention. The method of FIG. 5 below will be described as if performed by the first terminal, second terminal, and user identification information providing unit as shown in FIG. 3 and FIG. 4, but are not limited as such.

According to a user input, the first terminal 110 requests to establish a WiFi-Direct communication connection to the second terminal 120 in operation S100. In operation S101, the second terminal 120 also requests WiFi-Direct communication to the first terminal 110. Although FIG. 5 illustrates that the first terminal 110 as initiating the request before the second terminal 120, the order of which terminal first transmits the request between the first terminal 110 and the second terminal 120 is not limited thereto, such that the order may be reversed. Further, when only the first terminal 110 and the second terminal 120 are present to conduct WiFi-Direct communication, WiFi-Direct communication connection may be established for only the first terminal 110 and the second terminal 120.

Further, the first terminal 110 may send the device information of the first terminal 110 and the encoded phone number information of the first terminal 110 to the second terminal 120 in operation S102. Even though the first terminal 110 has been described as transmitting the device information and/or the encoded phone number information to the second terminal 120 herein, the second terminal 120 may receive device information and/or encoded phone number information from a third terminal (not shown), a fourth terminal (not shown) or the like.

In operation S103, the user inputs a request for searching communication-available terminals through the display unit 125 (see FIG.3) of the second terminal 120. In operation S104a, the first terminal 110 comes to a standby state, waiting for its connection to the second terminal 120.

In operation S104, the second control unit 123 (see FIG. 3) of the second terminal 120 searches for terminals capable of establishing a WiFi-Direct communication connection.

In operation S105, the second control unit 123 searches for a terminal having the encoded phone number information, which may be included in the identification information of other terminals received through the second data transmission unit 121.

In operation S106, if there is a terminal having the encoded phone number information, the decoder 124a (see FIG. 4) of the second terminal 120 decodes the encoded phone number information of the terminal. The decoding method may be determined according to the encoding method used for the encoded phone number information. For example, encoding/decoding operation may be performed by converting numbers to alphabets, or vice versa. In more detail, if 010-1234-5678 is encoded into ABC-DEFG-HUK, ABC-DEFG-HUK may be decoded into 010-1234-5678. However, aspects of the invention are not limited thereto, such that various encoding/decoding methods well known in the art may be applied.

In operation S107, the matching unit 124b (see FIG. 4) of the second terminal 120 compares the decoded phone number information with the phone number list stored in the storage unit 122 and determines whether a phone number matching with or corresponding to the decoded phone number information is present in the stored phone number list. For example, if the decoded phone number information is determined to be 010-1234-5678, the matching unit 124b may search for the same phone number 010-1234-5678 from phone numbers stored in the phone number list.

In operation S108, if a matching phone number is present in the phone number list stored in the second terminal 120, the user identification information collecting unit 124c (see FIG. 4) determines whether user identification information corresponding to the matched phone number is present or retrievable. A user corresponding to the matched phone number may be a user who uses, owns, or otherwise associated with the terminal corresponding to the matched phone number.

According to aspects of the invention, the phone number list may be stored in the terminal together with at least one of a phone number of other terminal, a name of other terminal user, an image of the user, a job of the user, an email address, a homepage address of the user, and the like. These information may be used as identification information for identifying a terminal and may support an easier or more efficient searching operation since these information are stored together in a category of a single user. Moreover, one or more pieces of information may be used as user identification information. For example, since an image or a name of a user may be easily recognized by a user, the image or name of the user may be provided as the user identification information.

Further, according to aspects of the invention, when the phone number list is associated with a social network service (SNS) application in the second terminal 120, user identification information that may not be present in the stored phone number list but included in the social network service application may be provided. For example, a phone number and a name of a user may be registered in a phone book application of the second terminal 120 but an image of the user may not be stored in the phone book application. A user profile having the same name as the user name stored in the phone book of the second terminal 120 may be searched for in the social network service application, and if an image is present in the user profile corresponding to the searched information, the image may be provided as the user identification information.

In operation S109, if user identification information corresponding to the matched phone number is present, the user identification information collecting unit 124c collects and provides the user identification information for the second control unit 123, and the display unit 125 displays the user identification information corresponding to the terminal.

In operation S110, the second control unit 123 provides information of terminals that may be available for establishing a WiFi Direction communication connection for the display unit 125, and the display unit 125 displays communication-available terminals in a list. In the list, some or all information of one of more terminals included in the list may be displayed.

Further, according to the data transmitted by the other terminal to the second terminal 120, the type of content displayed may vary. For example, when the encoded phone number information of the first terminal 110 is received, the second terminal 120 may display one or both of the user identification information of the first terminal 110 and/or the device information of the first terminal 110 for the first terminal 110. However, a third terminal (not shown), which may be connected to the second terminal 120, may not send encoded phone number information of the third terminal in operation S105. Further, when a phone number of the third terminal is not present in the phone number list stored in the second terminal 120 in operation S107, or when user identification information corresponding to the phone number of the third terminal is not present in the phone number list stored in the second terminal 120 in operation S108, the second terminal 120 may display only the device information of the third terminal for the third terminal.

In operation S111, the user selects a terminal to which target data is to be transmitted (e.g., first terminal 110). The terminal to receive the target data may be selected based on the information displayed on the display unit 125 of the second terminal 120. In operation S112, the second terminal 120 requests a communication connection to the selected terminal (e.g., first terminal 110) through the second data transmission unit 121 (see FIG. 3) for transmitting specific data. A communication connection for exchanging specific data, such as moving pictures, images or files between the first terminal 110 and the second terminal 120 may be established.

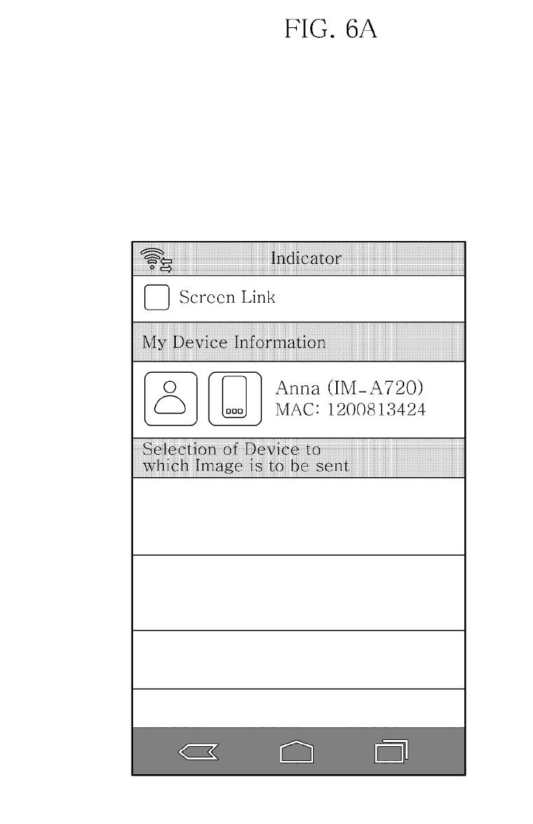

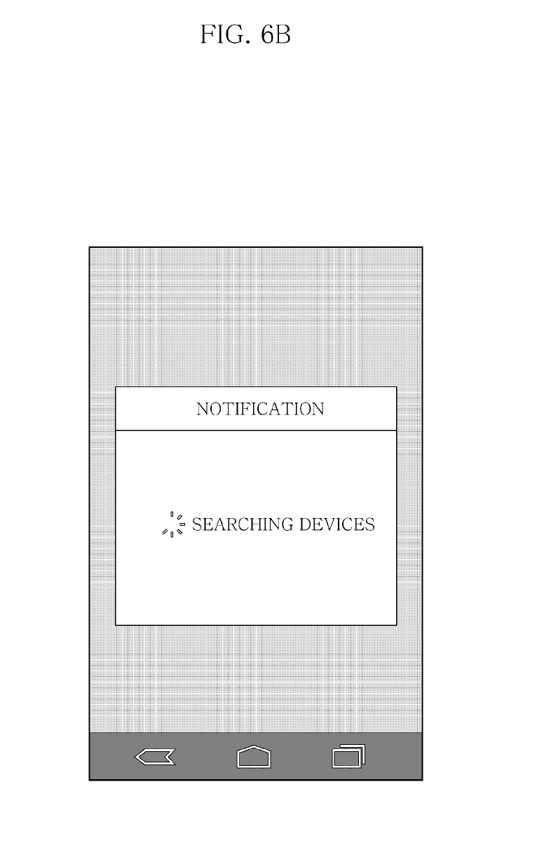

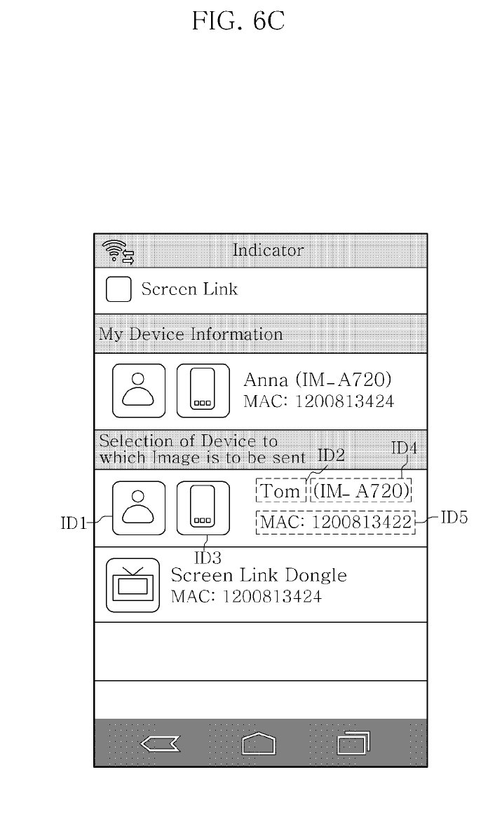

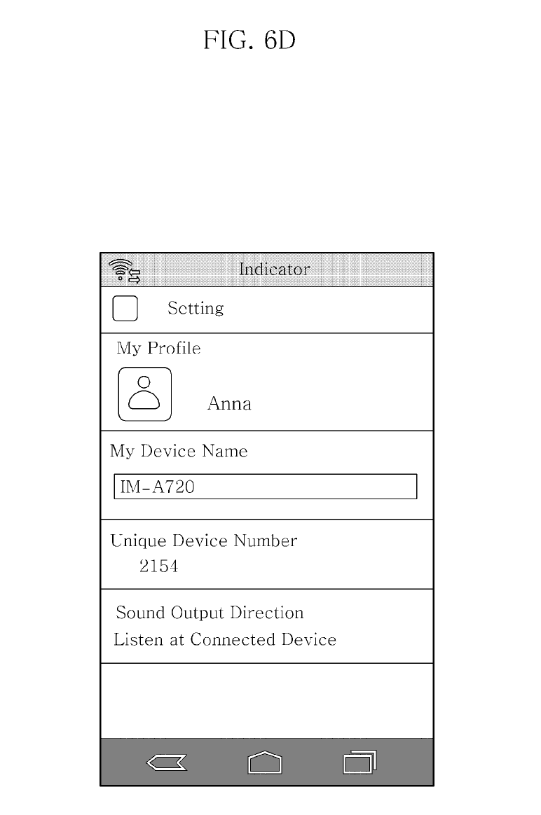

FIG. 6A, FIG. 6B, FIG. 6C, and FIG. 6D illustrate a user interface displayed on a terminal capable of establishing a WiFi-Direct communication connection according to an exemplary embodiment of the present invention.

An initial image or screen for connecting the WiFi-Direct communication may be displayed as shown in FIG. 6A. Referring to FIG. 6A, only the information of a second terminal is displayed in the “My Device Information” portion of the display. Device information or device name of IM-A720 is displayed in FIG. 6A. Further, a device image and a unique device number (MAC) of 1200813424 of the second terminal may also be displayed. Also, in FIG. 6A, identification information, such as a name of the user of Anna and an image of the user, of a user of the second terminal are provided as information of the second terminal. However, aspects of the invention are not limited thereto, such that less, more, or different set of information may be displayed.

According to an input of the user, terminals capable of WiFi-Direct communication with the second terminal may be searched for as shown in FIG. 6B.

The terminals identified through the search operation are provided in a list labeled “Selection of Device to which Image is to be sent” as shown in FIG. 6C. A terminal displayed at the top of the list may be a first terminal. Further, an image of the user of the first terminal (ID1), a name of the user (ID2), a device image (ID3), a device name of the first terminal (ID4) and a unique device number (ID5) are provided as identification information of the first terminal. Further, another terminal or a third terminal is listed below the first terminal in FIG. 6C. With respect to the third terminal, since the second terminal does not have user identification information, only device information, such as the device name of Screen Link Dongle, a unique device number (MAC) of 1200813424, and a device image of a television, is displayed.

Referring to FIG. 6D, if the first terminal is selected for establishing a communication connection, a screen displaying only the identification information of the second terminal is displayed. Further, a menu option for attempting or establishing a connection between the first terminal and the second terminal, such as “Sound Output Direction (e.g., listen at a connected device)”, is available for selection.

As described above, aspects of the invention may provide a user interface, which may allow a user to more easily identify other terminals when connecting terminals via WiFi-Direct communication. Accordingly, the user may recognize a target terminal more quickly for data exchange and reduce the likelihood of the user selecting a wrong terminal for connection.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A method for establishing a local wireless communication connection, comprising:
searching, by a first terminal, for a second terminal capable of establishing a local wireless communication connection with the first terminal;
obtaining identification information from the second terminal;
determining whether the identification information of the second terminal corresponds to information stored in the first terminal;
obtaining user identification information corresponding to the second terminal if the identification information of the second terminal corresponds to the information stored in the first terminal; and
displaying, on the first terminal, the user identification information of the second terminal for selection.

2. The method of claim 1, further comprising:
selecting the second terminal for establishing the local wireless communication connection; and
establishing, by the first terminal, the wireless communication connection with the second terminal.

3. The method of claim 1, further comprising:
determining whether the identification information of the second terminal is encoded; and
decoding the encoded information.

4. The method of claim 3, wherein the encoded identification information comprises a phone number of the second terminal.

5. The method of claim 1, wherein the user identification information comprises at least one of a name of a user of the second terminal and an image of the user of the second terminal.

6. The method of claim 1, wherein the information stored in the first terminal comprises a device identification list, the identification information received by the second terminal, and user identification information corresponding to the device identification list.

7. The method of claim 1, wherein the identification information of the second terminal comprises at least one of device information and a phone number of the second terminal.

8. The method of claim 1, wherein the obtaining user identification information comprises retrieving the user identification information from a storage unit of the first terminal.

9. The method of claim 1, wherein the obtaining user identification information comprises searching for user identification information using a social network service (SNS) if one or more pieces of the user identification information is not stored in the first terminal.

10. The method of claim 1, wherein the local wireless communication comprises at least one of a WiFi Direct communication, Bluetooth, near field communication (NFC), and WiFi Display.

11. A first terminal to establish a local wireless communication connection, comprising:
a data transmission unit to search to identify a second terminal capable of establishing a local wireless communication connection with the first terminal, and to obtain identification information from the second terminal;
a storage unit to store device identification list and user identification information corresponding to the device identification list;
a control unit to determine whether the identification information of the second terminal corresponds to information included in the device identification list;
a user identification information providing unit to obtain user identification information corresponding to the second terminal if the identification information of the second terminal corresponds to the information included in the device identification list; and
a display unit to display the user identification information of the second terminal for selection.

12. The first terminal of claim 11, wherein the control unit determines whether the identification information of the second terminal is encoded, and the user identification information providing unit decodes the encoded information.

13. The first terminal of claim 11, wherein the user identification information comprises at least one of a name of a user of the second terminal and an image of the user of the second terminal.

14. The first terminal of claim 11, wherein the user identification information providing unit obtains user identification information using a social network service (SNS) if one or more pieces of the user identification is not stored in the storage unit.

15. The first terminal of claim 11, wherein the local wireless communication comprises at least one of a WiFi Direct communication, Bluetooth, near field communication (NFC), and WiFi Display.

16. A method for establishing a local wireless communication connection, comprising:
searching, by a first terminal, for a second terminal capable of establishing a local wireless communication connection with the first terminal;
determining whether the second terminal is associated with an encoded phone number;
obtaining the encoded phone number associated with the second terminal;
decoding the encoded phone number;
determining whether the decoded phone number corresponds to a phone number stored in the first terminal;
determining whether user identification information corresponding to the decoded phone number is stored in the first terminal; and
displaying, on the first terminal, the user identification information in association with the second terminal for selection.
